(19) United States
(12) Patent Application Publication
(10) Pub. No.: US 2016/0063541 A1
(43) Pub. Date: Mar. 3, 2016

(54) METHOD FOR DETECTING BRAND COUNTERFEIT WEBSITES BASED ON WEBPAGE ICON MATCHING

(71) Applicant: COMPUTER NETWORK INFORMATION CENTER, CHINESE ACADEMY OF SCIENCES, Beijing (CN)

(72) Inventors: Guanggang GENG, Beijing (CN); Wei WANG, Beijing (CN)

(21) Appl. No.: 14/779,248

(22) PCT Filed: Dec. 18, 2013
(86) PCT No.: PCT/CN2013/089838

§ 371 Date: Sep. 22, 2015

(30) Foreign Application Priority Data
May 23, 2013 (CN) 201310195688.9

(51) Int. Cl. G06Q 30/02; H04L 29/06

(52) U.S. Cl. CPC G06Q 30/0248; G06Q 30/0277; H04L 63/1416

(57) ABSTRACT

The invention relates to a website icon matching-based detection method for brand counterfeit websites. The website icon matching-based detection method for the brand counterfeit websites comprises the following steps: (1) collecting icons of websites which have been counterfeited by greater than a set threshold value, and acquiring webpage icons of the websites to establish a brand icon image set BrandSet; (2) extracting webpage icons of the websites based on a plurality of webpage uniform resource locators (URL) of to-be-detected websites to establish a to-be-detected image set DetectSet; (3) matching images in the BrandSet with those in the DetectSet, and determining whether the two sets include matched images; (4) finding the webpage URLs associated with the matched images, and determining whether the webpage URLs associated with the matched images have right of use for the associated brand icons; and (5) identifying the webpage URLs without right of use for the brand icon in step (4) as brand counterfeit websites. The disclosed method of detecting counterfeit websites by right of webpage icon has not previously been utilized. The disclosed method is easy to implement, has high detection rate, and is easy to popularize.

### TECHNICAL FIELD

The present invention relates to a method for the detection of brand counterfeit websites, and in particular, to a method in the field of computer network for detecting counterfeit websites based on matching webpage icons to brand icons.

### BACKGROUND OF THE INVENTION

Brand counterfeiting, or phishing, refers to a cybercrime in which a phishing website disguises to be a legitimate brand website to gather sensitive personal information from users. Due to the popularity and development of e-commerce and Internet applications, phishing has caused increasingly serious losses to the Internet users. Brand counterfeiting fraud has become the biggest threat to Internet security, according to “Chinese Network Security Report in the first half of 2011” issued by 360 Safe™, the largest security company in China. The number of phishing attacks has increased significantly in recent years, as reported by International Anti-phishing Alliance. It has become particularly urgent to find effective phishing detection methods.

Currently, there are three main categories of techniques for detecting counterfeit brand websites:

1. Blacklisting;

2. Detection technologies based on features in uniform resource locators (URL); and

3. Detection technologies based on statistical analysis of multiple features.

The blacklist detection technique maintains and constantly updates a list of phishing sites through user evaluations or reports, to prevent additional users to visit phishing websites that have already been discovered. URL-based feature brand counterfeiting detection analyzes elements in the URL in conjunction with evaluating truthfulness of registration and resolution information to determine whether a website is a brand counterfeit. The URL based on detection is often used as a preliminary detection, while the final determination is usually based on web content. Finally, statistics based on multi-feature detection technique extracts a number of characteristics to statistically evaluate brand counterfeit scams.

Among the three above described detection technologies, the biggest drawback for the blacklist detection technique is in its time lag. The disadvantage of the URL-based method is that its detection can be defeated by modifying URL at low cost. Moreover, the URL-based method is incapable of detecting of large-scale counterfeiting of IDN domain names. The statistics based on multi-feature detection technique requires collection of massive number of phishing samples and content relevant characteristics. As a result, this method is not effective across different languages. Moreover, this method often relies on third-party resources (e.g. search engines, etc.), which limits the spread of this technique.

### SUMMARY OF THE INVENTION

In one general aspect, the present invention relates to a method for detection counterfeiting websites based on webpage icon matching, which includes steps of:

1) collecting brand websites whose brands have been counterfeited by numbers of times greater than a set threshold value; acquiring webpage icons of the brand websites; and establishing a brand icon image set BrandSet;

2) extracting webpage icons of the websites based on a plurality of webpage uniform resource locators (URL) of to-be-detected websites to establish a to-be-detected image set DetectSet;

3) matching images in BrandSet with images in DetectSet to determine whether BrandSet and DetectSet include matched images;

4) obtaining webpage URLs associated with the matched images; and determining whether the webpage URLs associated with the matched images have right of use for the associated icons;

5) identifying the webpage URLs without right of use for the icon as brand counterfeit websites; and

6) repeating steps 1)-3) according to a predetermined (periodic) schedule to detect counterfeit websites.

The step of establishing a brand icon image set BrandSet can include:

1) acquiring a hyperlink to a webpage icon file from the home page source code of a brand website;

2) acquiring one or more .ico type web icon files at the hyperlink; an extracting one or more binary image files from the one or more .ico type web icon files to build the BrandSet; and

3) storing the BrandSet in a database or in a file.

The step of determining whether the webpage URLs associated with the matched images have right of use for the associated icons can include:

1) acquiring URL, of a website at one of the to-be-detected websites associated with the matched images in BrandSet, determining if the domain names of the webpage and the associated brand website use the same domain name resolution server, and if the domain names use the same domain name resolution server, determining the website associated with the webpage URL to be legitimate; and

2) if the domain names do not use a same domain name resolution server, determining the website associated with the webpage URL to be normal with the right to use the associated icon if the domain names have the same prefix in their IP addresses; and determining the website associated with the webpage URL to be a counterfeit website if the domain names have different prefixes in their IP addresses.

The prefix can include first 16 bits in the respective IP addresses.

The step of collecting brand websites can be based on brands stored in PhishTank that have been counterfeited by greater than a set threshold value.

Each image in BrandSet can correspond to one or more of webpage URLs of the associated brand website.

The images in BrandSet and DetectSet can be matched based on globally or locally matching grayscale pixel values the images.

Each image in DetectSet can correspond to one or more of the webpage URL of the to-be-detected website.

The presently method can include one or more of the following advantages:

The presently disclosed methods extract and analyze webpage icons of brand counterfeiting website which has not been incorporated in conventional detection methods. Furthermore, the presently disclosed method is not limited by language differences, has high successful detection rate, and can be easily implemented and popularized. The presently disclosed method screens webpages by matching webpage icons with brand icons, and further determines if a URL associated with a matching webpage icon has the right to use a brand icon, in order to make a final determination on whether the corresponding URL is associated with brand counterfeiting fraud.

### BRIEF DESCRIPTION OF THE DRAWINGS

FIG. 1 is a flow chart for building a set of webpage icon image from to-be-detected websites and for detecting brand counterfeiting websites based on webpage icon matching in accordance with the present invention.

### DETAILED DESCRIPTION OF THE INVENTION

Based on the foregoing, the present invention provides a method for detecting brand counterfeiting websites by evaluating webpage icons, which effectively complements to existing methods. The presently disclosed method is agnostic to the languages of web content, and can be easily implemented.

The present invention takes advantage of the characteristics that vast majority of brand counterfeiting websites use fake webpage icon to deceive Internet users, and has developed a fraud detection method based recognizing webpage icons that may counterfeit legitimate brands. The presently disclosed method includes matching webpage icon image, and further screen websites based on the right of use of such webpage icons, in order to finally making a determination on whether a website is legitimate or counterfeit.

The presently disclosed method for detecting brand counterfeiting websites by evaluating webpage icons, which is insensitive to language types of web content, has high detection rate, and can be easily popularized.

With the development and spread of the Internet, webpage icon (Favicon) has become part of the corporate brand identity, which is also recognized by brand counterfeiting criminals. By analyzing a large amount of phishing samples in PhishTank (details can be found at “http:” followed by “//www.phishtank.com/developer_inf0.php”), applicants have found that brand counterfeit websites use webpage icons deceive Internet users.

The presently disclosed method compares web icons at a to-be-detected URL (“http:” followed by “//www.sample.com/path”) to frequently counterfeited legitimate brand icons, followed by a determination of right of use for the web icon, in order to determine whether the website is a counterfeit.

### Detailed Implementations

The accompanying drawings and the following specific examples further illustrate the technical solution of the implements of the disclosed methods. The present invention is not limited to the specific examples of such implementations.

First, the preparatory work includes collecting webpage icons of brands that are frequently counterfeited. The method can include acquiring a hyperlink to a webpage icon file from the home page source code of the brand website. Several forms for webpage icon links are shown in Table I. Then the icon file is acquired at the hyperlink. An icon image is extracted from the icon file (an icon file usually has a suffix .ico and contains multiple images), which is added to a brand image set BrandSet. The presently disclosed method does not require BrandSet to be in a specific form: it can be stored in a file format, or in a database, etc.

In the detection phase, for each to-be-detected webpage, the first step is to obtain webpage code at the URL and to extract web icon file, The webpage icon image is extracted from the web icon file to be stored in the to-be-detected image set DetectSet.

TABLE 1
Association methods between webpage icons and webpages.

| | |
|---|---|
| Example 1 | <link rel=″shortcut icon″ href=″http://example.com/image. |
| | ico″ /> |
| Example 2 | <link rel=″icon″ type=″image/vnd.microsoft.icon″ href= |
| | ″http://example.com/image.ico″ /> |
| Example 3 | <link rel=″icon″ type=″image/png″ href= ″http://example.com/ |
| | image.png″ /> |
| Example 4 | <link rel=″icon″ type=″image/gif″ href=″http://example.com/ |
| | image.gif″ /> |
| Example 5 | “favicon.ico” file is stored in the root directory of the website. |

In step two, the images in DetectSet are matched to images in BrandSet. The image matching can be based on, but not limited to, color, texture, and other image characteristics. The finding of matching between a pair of images leads to step three. If no image matching has been found for all the webpage icons from a website, it is determined that this website is not involved in brand counterfeiting.

In step three, it is determined whether the URL is authorized to use the brand icon whose matching has been found in the webpage icon at the URL. If the URL or the website does not have right to use the brand icon, the website is determined to be a brand counterfeiting. The disclosed method is not limited the specific method in determining right of use. For example, the authorization of brand icon usage can be based on the domain name of the URL, the name resolution server of the legitimate brand domain name, and the resolution IP addresses, etc.

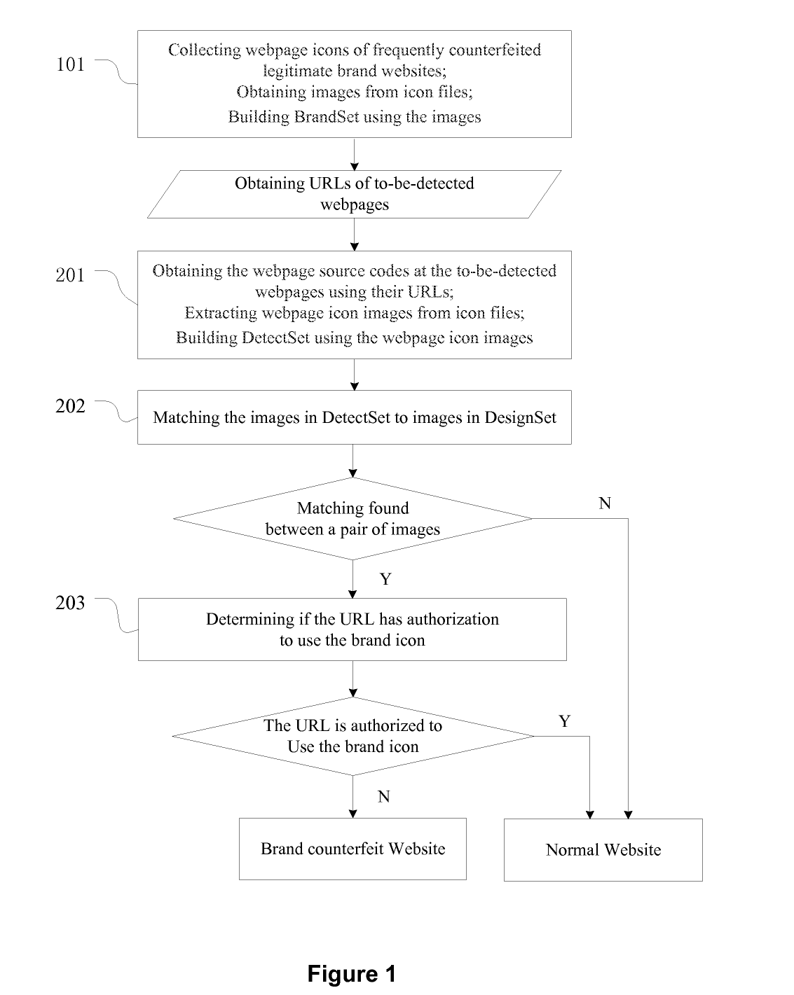

FIG. 1 is a flow chart for building a set of webpage icon image from to-be-detected websites and for detecting brand counterfeiting websites based on webpage icon matching in accordance with the present invention.

in Step 101, webpage icons of frequently counterfeited legitimate brand websites are collected by a computer system. (i.e. These brands have been counterfeited by greater than a set threshold value) Examples of such brands include Taobao, Tencent, Paypal, and so on. The collection of web icons requires prior understanding the format of association between the webpage icons and the web pages. Some examples of such associations are shown in Table I and used in the present implementations. Of course, it is understood that other types of associations can be used by the skilled practitioner in this field and are compatible with the presently disclosed methods.

After obtaining the webpage icon ICO files, in consideration that each ICO file typically includes multiple binary BMP image files, the images in the ICO file are extracted and used to build a brand icon image set BrandSet in computer storage. ICO is an icon file format; each ICO file stored one or multiple images.

In Step 201, using URLs of the to-be-detected webpages, the webpage source codes are obtained at the to-be-detected webpages. The webpage icon files are obtained. Webpage icon images are extracted from the icon files and are used to build DetectSet in the computer storage.

In Step 202, the computer system attempts to match images in DetectSet and BrandSet. The image matching is compatible with many different techniques (see for example Bahram Javidi (ed), “Image Recognition and Classification. Algorithms, Systems, and Applications”, CRC Press, 2002.), and is not limited by the examples provided in the presently disclosed implementations. The images between the two image sets can be matched using image colors and image textures. The present implementation also describes an example of image matching algorithm based on global and local pixel gray values, as shown in Method I below:

### Method 1: Greyscale Based Webpage Icon Image Matching

Input: IMG₁, IMG₂: image 1 and image 2;
K₁,K₂,K₃,N: threshold values;
Output: TRUE or FALSE.
Step1: Calculate average pixel greyscales of IMG1 [symbol] IMG2—avg(IMG1) and avg(IMG2); If |avg(IMG1)−avg(IMG2)|<K1, go to Step2; Otherwise, return FALSE;
Step2: Calculate average pixel greyscales in each row of IMG₁ and IMG₂—avg(rowᵢ(IMG₁)) and avg(rowᵢ(IMG₂)); For each rowᵢ, if |avg(rowᵢ(IMG₁))−avg(rowᵢ(IMG₂))|>K₂, return FALSE;
Step3: Calculate average pixel greyscales in each column of IMG₁ and IMG₂—avg(colᵢ(IMG₁)) and avg(colᵢ(IMG₂)); For each columnᵢ, if |avg(colᵢ(IMG₁))−avg(colᵢ(IMG₂))|>K₂, return FALSE;
Step4: For the N pixels in the center of each of IMG₁ and IMG₂, for each pixel i, if |IMG₁(i)−IMG₂(i)|>K₃, return FALSE; Otherwise, return TRUE.

In Method 1, if a certain brand icon in BrandSet (e.g. its website may be at: http: //www.brand.com) is successfully matched to the webpage icon at a to-be-detected webpage in DetectSet, the process proceeds to step 203. Otherwise, the webpage at URL is determined to be legitimate (i.e. a normal website).

In Step 203, it is determined whether the URL is authorized to use the brand icon. In the present implementation, the domain portion of the URL, that is the italic portion in http: followed by //www.sample.com/, is extracted. The name servers at brand.com and sample.com are compared by the computer system to check whether they use the same domain name resolution servers. If so, the webpage at the URL is determined to be legitimate (i.e. a normal website). Otherwise, the resolution IP addresses of the two domains are further compared. If the resolution IP addresses have the same prefix, the webpage at the URL is determined to be legitimate (i.e. a normal website). Otherwise, the webpage at URL is determined be a brand counterfeiting site. In Step 203, an example for the prefix of the IP address is IPv4 address (which is 32 bit long), include the first 16 bits. Most large companies have the same prefix length in their IP addresses.

In summary, the presently disclosed methods detect brand counterfeiting and fraud by identifying webpage icons that of the phishing websites. The presently disclosed method is applicable to all languages and is not limited by language types. The disclosed method has high successful detection rate, and can be easily implemented and popularized.

While the invention disclosed embodiments described above, but it is not intended to limit the present invention. Any skilled in the art, without departing from the spirit and scope of the present invention can be used for any alterations or equivalents. The scope of the present invention should be defined by the scope of the claims.

What is claimed is:

1. A method for detection counterfeiting websites based on webpage icon matching, comprising:
1) collecting brand websites whose brands have been counterfeited by numbers of times greater than a threshold value;
acquiring webpage icons of the brand websites; and
building a brand icon image set BrandSet using the webpage icons of the brand websites;
2) extracting webpage icons from to-be-detected websites using webpage uniform resource locators (URLs) to build a to-be-detected image set DetectSet;
3) matching images in BrandSet with images in DetectSet to determine whether BrandSet and DetectSet include matched images;
4) obtaining webpage URLs associated with matched images; and
determining whether the webpage URLs associated with the matched images have right of use for the associated webpage icons of the brand websites;
5) identifying the webpage URLs without right of use for the icon as brand counterfeit websites; and
6) repeating steps 1)-3) according to a predetermined schedule to detect counterfeit websites.

2. The method of claim 1, wherein the step of establishing a brand icon image set BrandSet comprises:
1) acquiring a hyperlink to a webpage icon file from home page source code of a brand website;
2) acquiring one or more .ico type web icon files at the hyperlink; and
extracting one or more image files from the one or more .ico type web icon files to build the BrandSet; and
3) storing BrandSet in a database or in a file.

3. The method of claim 1, wherein the step of matching images in BrandSet with images in DetectSet comprises:
matching image color or image texture between images in BrandSet and DetectSet.

4. The method of claim 1, wherein the step of determining whether the webpage URLs associated with the matched images have right of use for the associated icons comprises:
1) acquiring URL of a webpage at one of the to-be-detected websites associated with the matched images in BrandSet;
determining if domain names of the webpage and the associated brand website use the same domain name resolution server; and
if the domain names use the same domain name resolution server, determining the website associated with the webpage URL to be legitimate; and
2) if the domain names do not use a same domain name resolution server, determining the website associated with the webpage URL to be legitimate if the domain names have the same prefix in their IP addresses; and
determining the website associated with the webpage URL to be a counterfeit website if the domain names have different prefixes in their IP addresses.

5. The method of claim 4, wherein the prefix includes first 16 bits in the respective IP addresses.

6. The method of claim 1, wherein the step of collecting brand websites is based on brands stored in PhishTank that have been counterfeited by greater than a threshold value.

7. The method of claim 1, wherein each image in BrandSet corresponds to one or more webpage URLs of the associated brand website.

8. The method of claim 1, wherein the images in BrandSet and DetectSet are matched based on globally or locally matching grayscale pixel values the images.

9. The method of claim 1, wherein each image in DetectSet corresponds to one or more webpage URLs of a to-be-detected website.
